(19) United States
(12) Patent Application Publication
(10) Pub. No.: US 2003/0058789 A1
(43) Pub. Date: Mar. 27, 2003

(54) SDH ring network

(76) Inventors: Eiji Sugawara, Kawasaki (JP); Katsuya Kitamori, Kawasaki (JP)

Correspondence Address: KATTEN MUCHIN ZAVIS ROSENMAN, 575 MADISON AVENUE, NEW YORK, NY, 10022-2585, US

(21) Appl. No.: 10/074,337

(22) Filed: Feb. 12, 2002

(30) Foreign Application Priority Data
Sep. 21, 2001 (JP) 2001-288804

(51) Int. Cl. H04J 1/16; H04L 12/28

(52) U.S. Cl. 370/222; 370/401

(57) ABSTRACT

An SDH ring network is disclosed, which comprises a transmission & reception node; and a PCA insertion & reception node, which are interconnected in a ring form. The transmission & reception node includes a first function portion for setting a working path and a protection path in advance, a second function portion for setting a transmission value into the K3 or K4 byte in the overhead part of an SDH signal independently on the working path and the protection path, and a path switch for selecting either the working path or the protection path depending on the state of the received K3 or K4 byte, and the PCA insertion & reception node includes an insertion switch for selecting either a received signal is to be passed through or a PCA (Protection Channel Access) signal is to be inserted thereto, and a bridge for dropping a received signal and at the same time passing through the received signal.

### FIELD OF THE INVENTION

The present invention relates to an SDH (Synchronous Digital Hierarchy) ring network and more particularly an SDH ring network employing a protection path access (PCA) in an SDH path switch ring.

### BACKGROUND OF THE INVENTION

SDH (Synchronous Digital Hierarchy) system is configured with a hierarchical multiplexing structure as shown in FIG. 1. In transmission line layer such as STM1, STM4, STM16, there are provided a regenerator section overhead (RSOH) and a multiplex section overhead (MSOH). Also in virtual channel path layer of VC12, VC3, VC4, etc., there are provided overhead bytes (OHB) of a path overhead (POH).

Using these overhead bytes, SDH system enables to provide an advanced maintenance facilities as well as various network applications.

Meanwhile, in view of network application configuration, there is employed a ring system constituted by a plurality of nodes (Node#A to Node#F) being interconnected by optical fibers in a ring form, as shown in FIG. 2. In the example shown in FIG. 2, when communication is carried out between terminals being connected to Node#A and Node#B, an upward path and a downward path are formed through Node#A-Node#F-Node#E-Node#B.

In the description of the present invention, it is to be noted that a ring system does not only mean a network system constituted by a physical transmission ring network as explained above. The present invention is also applicable to a network in which a ring is logically constituted by virtual channels (VC), such as an SDH network having a mesh structure.

As a measure against a failure in such SDH network, a redundant configuration is provided. In a ring system, there are two system types having such redundancy.

UPSR (Uni-directional Path Switch Ring)

BLSR (Bi-directional Line Switch Ring)

The UPSR is a method in which a signal is transmitted from a transmission node in both ways on the ring using virtual paths VCn, such as VC4, VC3 and VC12, and the signal is received in a reception node in which either of the signals having better transmission quality is selected. In FIG. 3, there is shown a transmission using the UPSR method from Node#A to Node#B in the ring system shown in FIG. 2. The path having better line transmission quality is selected in Node#B.

For this purpose, in Node#A and Node#B, a path switch (PSW) is set so as to select in Node#B a path through, for example, Node#A-Node#F-Node#E-Node#B, as shown in FIG. 3.

Here, a switchover of the path switch (PSW) in Node#B is triggered when detecting either an error in Bit Interleaved Parity using B3 byte in an SDH frame, a path trace mismatch using J1/J2 byte, or a signal label mismatch using C2 byte.

As described above, the reception node side switches over a path in the UPSR. This enables a reduced circuit configuration with simple switchover control. The network capacity in this method is a total capacity of STMn irrespective of the number of nodes provided in the network.

Meanwhile, the BLSR is a method in which a half bandwidths provided in the lines such as STM1, STM4, STM16 are allocated for the protection bandwidths. In the BLSR method, a switchover is triggered by a detected failure in an STM signal.

Basically, the aforementioned protection bandwidths are reserved for relieving network traffic from a failure. However, it is also possible to use protection bandwidths for transmitting low priority traffic signals when there is no failure, so as to increase network capacity. This method is referred to as ‘Protection Channel Access (PCA)’, and enables to increase the network capacity more than STMn depending on the number of nodes and a path connection condition between nodes.

Despite the above-mentioned advantage in network capacity, there is a problem in the BLSR when adopting the Protection Channel Access (PCA) method. In order to perform switchover control totally as a matter of the network concerned, it is required for the entire nodes to set using a squelch table, etc., which brings about complicated circuit configuration and switchover control.

### SUMMARY OF THE INVENTION

It is therefore an object of the present invention to provide an SDH ring network with increased network capacity by incorporating the Protection Channel Access (PCA) into the UPSR method, obtaining with a simple circuit configuration and switchover control mechanism.

As a first embodiment of an SDH ring network to solve the aforementioned problem, according to the present invention, the SDH ring network includes a transmission & reception node and a PCA insertion & reception node being interconnected in a ring form. The transmission & reception node further includes; a function portion for setting a working path and a protection path in advance; a function portion for setting a transmission value into K3 byte or K4 byte (K3/K4 byte) in the overhead part of an SDH signal independently on the working path and the protection path; and a path switch for selecting either the working path or the protection path depending on the state of a received K3/K4 byte. Also, the PCA insertion & reception node further includes; an insertion switch for selecting either a received signal is to be passed through or a PCA (Protection Channel Access) signal is to be inserted thereto; and a bridge for dropping a received signal and at the same time passing through the received signal.

As a second embodiment of an SDH ring network to solve the aforementioned problem, in the above-mentioned first embodiment of the SDH ring network, the transmission & reception node sets the following transmission values in the K3/K4 byte: A signal condition SC indicating ‘PCA inapplicable’ is set for the working path, while a signal condition SC indicating ‘PCA applicable’ and a switch condition SWC indicating ‘switchover not requested’ are set for the protection path when the network is maintained in an ordinary state having no failure. Meanwhile, when a failure is detected on the working path, a switch condition SWC indicating ‘request for switchover’ is set to transmit, and on receipt of the switch condition SWC indicating ‘request for switchover’, a signal condition SC indicating ‘PCA inapplicable’ is set for the protection path.

As a third embodiment of an SDH ring network to solve the aforementioned problem, in the above-mentioned first embodiment of the SDH ring network, when receiving a pass-through signal having the signal condition SC of ‘PCA applicable’ in the K3 or K4 byte, the PCA insertion & reception node selects PCA signal to transmit a PCA output signal. At the same time, a switch condition SWC in the PCA output signal is replaced with the switch condition SWC received in the K3 or K4 byte of a pass-through signal input, and also a signal condition SC indicating ‘PCA’ is set into the K3 or K4 byte. When receiving a pass-through signal having the signal condition SC of “PCA inapplicable” in the K3 or K4 byte, the PCA insertion & reception node selects the pass-through signal input and outputs the pass-through signal to the PCA output signal.

As a fourth embodiment of an SDH ring network to solve the aforementioned problem, in the above-mentioned first embodiment of the SDH ring network, when receiving a drop or pass-through signal having a signal condition SC of ‘PCA’ in the K3 or K4 byte, the PCA insertion & reception node selects a PCA signal in the pass-through signal input and outputs the PCA signal. When receiving a drop or pass-through signal having a signal condition SC of other than ‘PCA’ in the K3 or K4 byte, the PCA insertion & reception node outputs an alarm indication signal (AIS) in the PCA output signal.

As a fifth embodiment of an SDH ring network to solve the aforementioned problem, in the above-mentioned second or fourth embodiment of the SDH ring network, the transmission & reception node monitors a PDH input signal. On detection of a failure in the PDH input signal, the transmission & reception node fixes a signal condition SC indicating ‘PCA applicable’ and a switch condition SWC indicating ‘no request for switchover’ in the K3/K4 byte for the protection path. The PCA insertion node continues inserting a PCA signal.

As a sixth embodiment of an SDH ring network to solve the aforementioned problem, in the above-mentioned second or fourth embodiment of the SDH ring network, the transmission & reception node monitors a VCn input signal. On detection of a failure in the VCn input signal, the transmission & reception node fixes a signal condition SC indicating ‘PCA applicable’ and a switch condition SWC indicating ‘no request for switchover’ in the K3/K4 byte for the protection path. The PCA insertion node continues inserting a PCA signal.

As a seventh embodiment of an SDH ring network to solve the aforementioned problem, in the above-mentioned second or fourth embodiment of the SDH ring network, the PCA insertion & reception node monitors a PDH PCA signal input. On detection of a failure in the PDH PCA signal input, the PCA insertion & reception node fixes a selection condition so as to select a pass-through signal input, to obtain the UPSR configuration without applying PCA so as to shorten a failure relief time.

As an eighth embodiment of an SDH ring network to solve the aforementioned problem, in the above-mentioned second or fourth embodiment of the SDH ring network, the PCA insertion & reception node monitors a VCn PCA signal input. On detection of a failure in the VCn PCA signal input, the PCA insertion & reception node fixes a selection condition so as to select a pass-through signal input, to obtain the UPSR configuration without applying PCA.

Further scopes and features of the present invention will become more apparent by the following description of the embodiments with the reference of the accompanied drawings.

### BRIEF DESCRIPTION OF THE DRAWINGS

FIG. 1 shows a hierarchical multiplexing SDH signal configuration in an SDH (Synchronous Digital Hierarchy) system.

FIG. 2 shows a ring system configuration as one of the network application configuration.

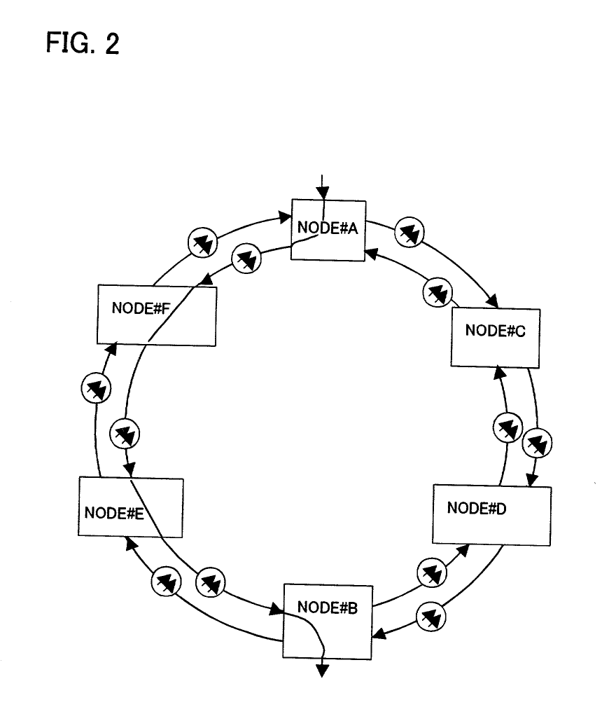

FIG. 3 shows a diagram of transmission from Node#A to Node#B using the UPSR method.

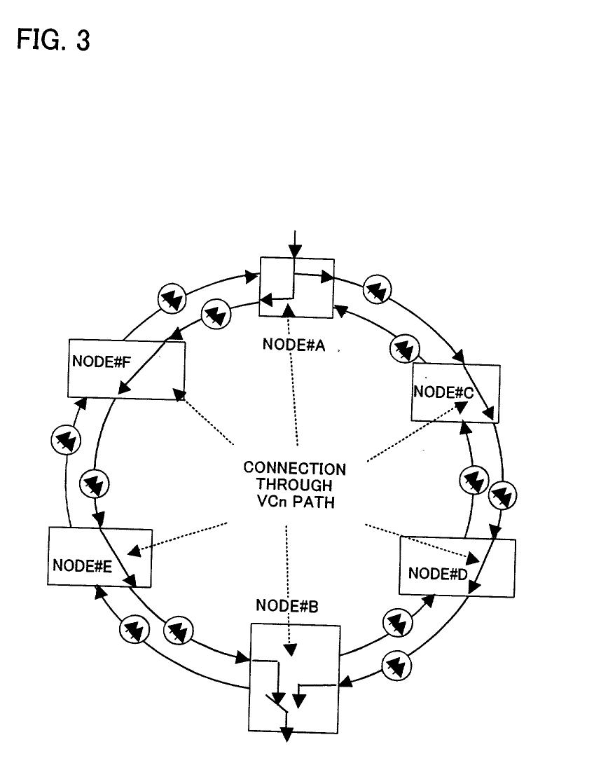

FIG. 4 shows a basic concept of the present invention, illustrating an example of transmission/reception between Node#A and Node#B in the ring system shown in FIG. 2.

FIG. 5 shows a configuration example of the first 4 bits of the K3/K4 byte.

FIG. 6 shows a configuration example of the last 4 bits of the K3/K4 byte.

FIG. 7 shows a functional block diagram of a reception node and a transmission node (Node#C and Node#D in FIG. 4) corresponding to the TRP method.

FIG. 8 shows a functional block diagram of an insertion node and a reception node (Node#A and Node#B in FIG. 4) corresponding to the TRP method.

FIG. 9 shows a functional block diagram of PCA signal reception node and transmission node (Node#A and Node#B in FIG. 4) corresponding to the SNCP method.

FIG. 10 shows a functional block diagram of an insertion node and a reception node (Node#C and Node#D in FIG. 4) corresponding to the SNCP method.

FIG. 11 shows a diagram illustrating values of the K3/K4 byte, and conditions of a path switch (PSW), an insertion switch (ADD SW) and a bridge in an ordinary state (i.e. no failure state).

FIG. 12 shows an operation example of the present invention in case of a failure occurring on a working side from Node#A to Node#B (part 1).

FIG. 13 shows an operation example of the present invention in case of a failure occurring on a working side from Node#A to Node#B (part 2).

FIG. 14 shows an operation example of the present invention in case of a failure occurring on a working path from Node#B to Node#A (part 1).

FIG. 15 shows an operation example of the present invention in case of a failure occurring on a working path from Node#B to Node#A (part 2).

FIG. 16 shows an operation example of the present invention in case of failure recovery occurring on a path from Node#A to Node#B (part 1).

FIG. 17 shows an operation example of the present invention in case of failure recovery occurring on a path from Node#A to Node#B (part 2).

FIG. 18 shows an operation example of the present invention in case of failure recovery occurring on a working path from Node#B to Node#A (part 1).

FIG. 19 shows an operation example of the present invention in case of failure recovery occurring on a working path from Node#B to Node#A (part 2).

### DETAILED DESCRIPTION OF THE PREFERRED EMBODIMENTS

The preferred embodiments of the present invention are described hereinafter referring to the charts and drawings, wherein like numerals or symbols refer to like parts.

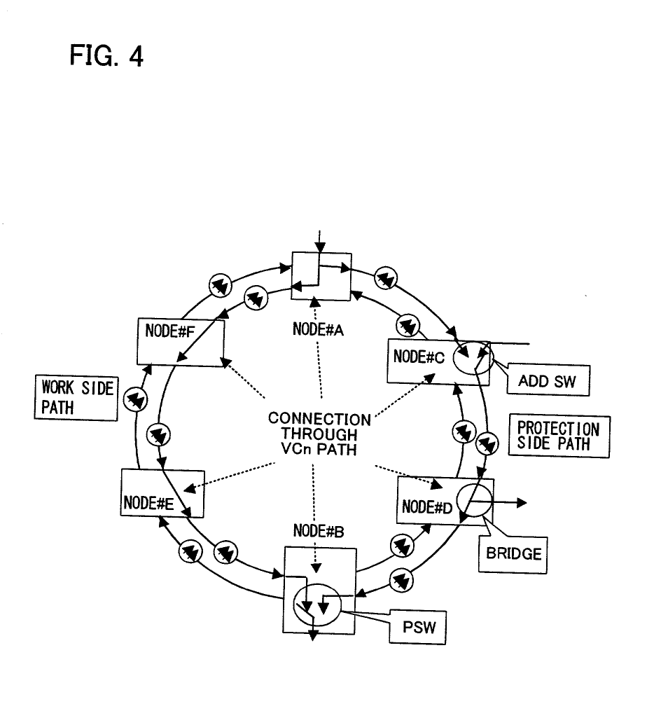

FIG. 4 shows a basic concept of the present invention. In the ring system of FIG. 4, an example of transmission and reception between Node#A and Node#B is shown. In the following description, Node#A and Node#B performing transmission and reception are respectively defined as transmission & reception nodes.

Signals are transmitted from Node#A in both directions of the ring being directed to Node#B. Either of the paths through which the signals are transmitted in the two directions is selected by a path switch (PSW) provided in Node#B. The above-mentioned selected path is referred to as a working path.

An ADD switch and a bridge are provided on a protection path, in each node to perform a Protection Channel Access.

In the example shown in FIG. 4, Protection Channel Access (PCA) is performed between Node#C and Node#D. For this purpose, data are inserted in Node#C using an insertion switch (ADD switch), and data are made to branch in Node#D using a bridge. In the following description, Node#C and Node#D performing the data insertion and the data branching are defined as PCA insertion & reception nodes.

In one embodiment of the present invention, one (1) byte in the path overhead is used for controlling the path switch (PSW), the insertion switch (ADD switch) and the bridge.

Because a concrete usage is not defined in the ITU-T recommendations, for example, K3 byte in a VC4 or VC3 path and K4 byte in a VC12 path can be assigned for controlling the aforementioned path switch (PSW), insertion switch (ADD switch) and bridge.

In this description of the present invention, K3 byte or K4 byte (K3/K4 byte) has the following format: K3/K4 byte configuration

TABLE 1

| | | | | | | | |
|---|---|---|---|---|---|---|---|
| 1 | 2 | 3 | 4 | 5 | 6 | 7 | 8 |

| | |
|---|---|
| Signal Condition | Switch Condition |

Here, a signal condition (SC) includes the following information:

HP: high priority (PCA inapplicable)

LP: low priority (PCA applicable)

PCA: PCA (protection channel access)

DNU: do not use (use forbidden)

Also, a switch condition (SWC) includes the following information:

NR: no request (no request for switchover)

SR: switch request (request for switchover)

BK: blank (dummy signal)

DNU: do not use (use forbidden)

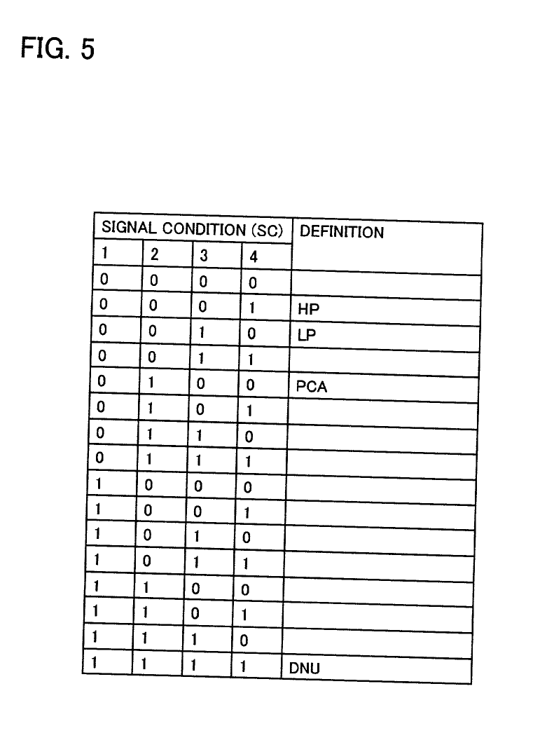

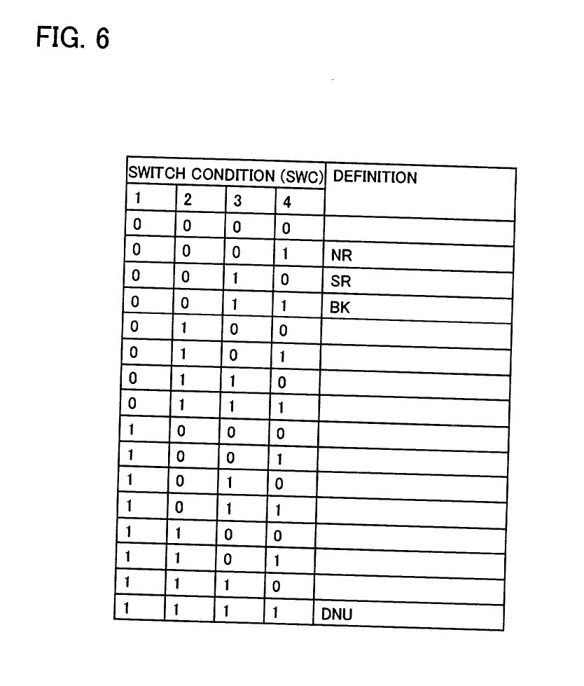

In FIGS. 5 and 6, there are shown coding examples for the signal conditions (SC) and the switch conditions (SWC) in the K3/K4 byte. For example, in FIG. 5, the first four (4) bits of the K3/K4 byte are shown, where ‘0001’ denotes the aforementioned HP, ‘0010’ denotes LP, ‘0100’ denotes PCA, and ‘1111’ denotes DNU, respectively. Also, in FIG. 6, the last 4 bits in the K3/K4 byte are shown, where ‘0001’ denotes the aforementioned NR, ‘0010’ denotes SR, ‘0011’ denotes BK, and ‘1111’ denotes DNU, respectively.

Referring back to FIG. 4, the operation is described in more detail. In FIG. 4, there is shown a network connection (inter-nodal connection) in accordance with the present invention, as well as a virtual path (VC path) connection in each node. Node#F and Node#E are connected on the working path from Node#A to Node#B, and also Node#D and Node#C are connected on the working path from Node#B to Node#A, with respective virtual channel paths (VCn).

Here, the function of multiplexing/demultiplexing a VC path signal and an optical STM signal are not shown in FIG. 4.

In Node#A and Node#B respectively acting as transmission & reception nodes, there are provided a function for transmitting the K3/K4 byte individually through a working path (the path having no PCA) and a protection path (the path having PCA in the middle of the path). Also there is provided a path switch (PSW) for selecting either the working path or the protection path.

Node#C performing the protection channel access (PCA) function provides an insertion switch (ADD SW) for selecting either a protection path is to be made pass through or a PCA signal is to be inserted. Also, Node#C provides a function of setting a signal condition (SC) value corresponding to the pass-through signal in the SC field of the K3/K4 byte when pass-through is selected, and a function of transmitting a PCA signal when the PCA function is selected.

Further, Node#D provides functions of dropping a received signal and passing through (or bridging) the received signal.

Here, the path switch protection method performed in the aforementioned nodes can be classified into the following two methods: a Trial Protection (TRP) method and a Sub Network Connection Protection (SNCP) method.

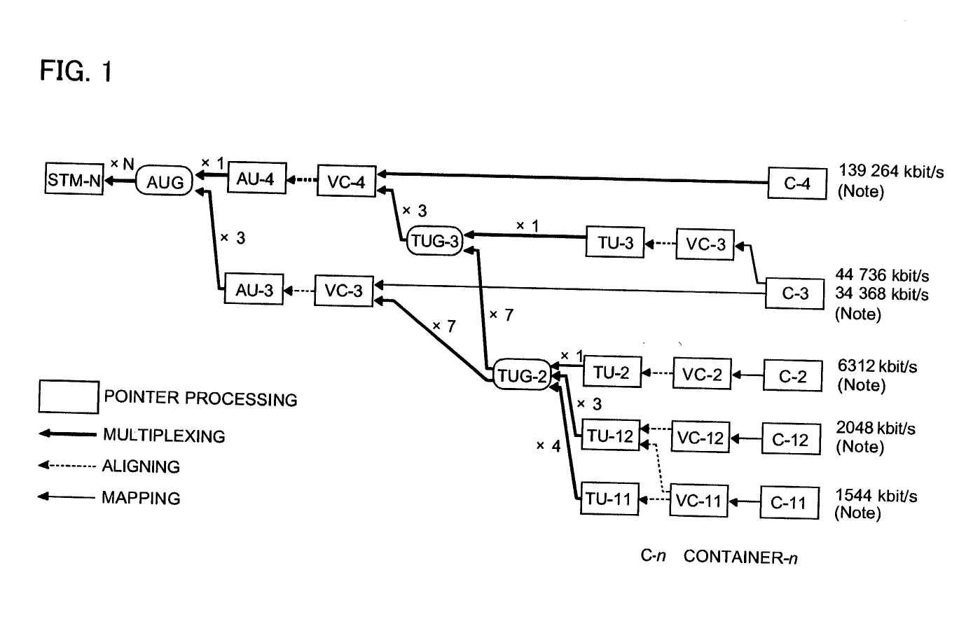

In the TRP method, a working path and a protection path are managed independently, in which path switching is performed on an SDH signal level basis (refer to C-2, C-3, C-4, etc. in FIG. 1).

Meanwhile, in the SNCP method, path switching is performed on a VC path basis. Accordingly, different functional blocks are required for the TRP method and the SNCP method.

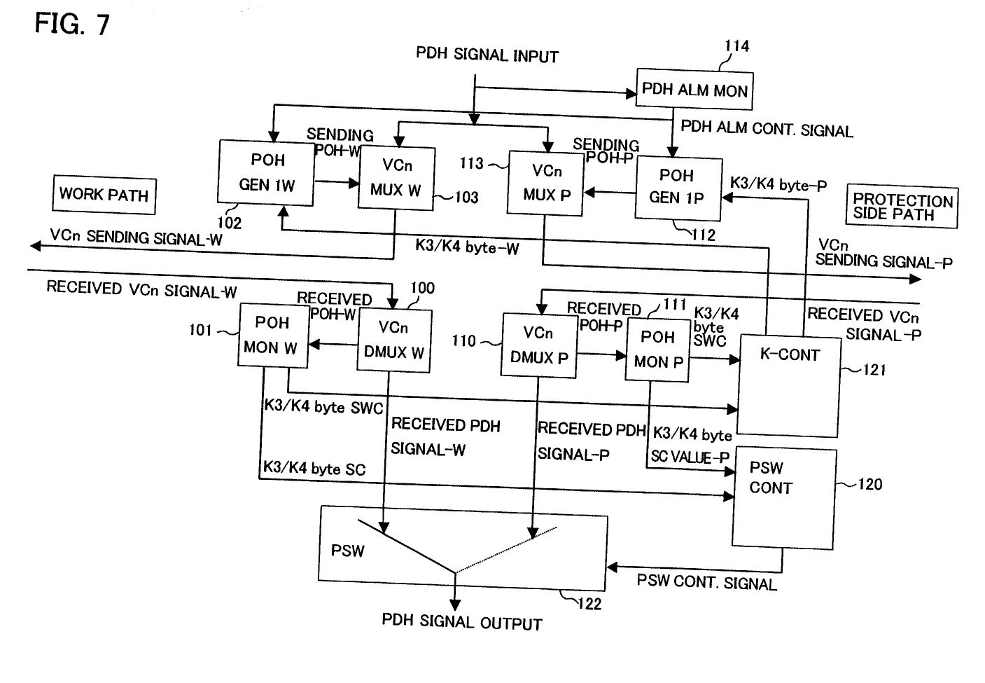

FIG. 7 shows a functional block diagram of the reception node and the transmission node (Node#A and Node#B in FIG. 4) corresponding to the TRP method.

In FIG. 7, a VCn demultiplexer (DMUX W) 100 on the working path side demultiplexes a received PDH signal of the working side from a VCn signal received on the working path. Similarly, a Vcn demultiplexer (DMUX P) 110 on the protection path side demultiplexes a received PDH signal of the protection side from a VCn signal received on the protection path.

A POH monitor 101 on the working side extracts the signal condition SC in the K3/K4 byte of the received path overhead (POH) to transfer to a path switch controller (PSW-CONT) 120. POH monitor 101 also transfers the switch condition SWC in the K3/K4 byte to a K-byte controller 121. Similarly, aPOH monitor 111 on the protection side extracts the signal condition SC in the K3/K4 byte of the received path overhead (POH) to transfer to path switch controller (PSW-CONT) 120. POH monitor 111 also transfers the switch condition SWC in the K3/K4 byte to K-byte controller 121.

Path switch controller (PSW-CONT) 120 determines the selection of path switch (PSW) 122 based on the value of the signal condition SC in the K3/K4 byte received on the working and protection sides, to perform switching control.

Based on the switch condition SWC value, K-byte controller 121 determines the value of the K3/K4 byte to be set into POH generators 102, 112 on the working and protection sides. Each POH generator 102, 112 generates a K3/K4 byte being set from K-byte controller 121 and other path overhead (POH) to prepare a transmission POH information. Further, VCn multiplexers (MUX) 103, 113 on the working and protection sides multiplex the transmission POH and input PDH (path digital hierarchy) signal input to generate a VCn transmission signal for the working and protection sides.

Here, in TR method, when a failure occurs in a PDH signal input, it is no use to relieve VCn signal against the failure. In such a case therefore, PCA should be continued.

For this purpose, a PDH alarm monitor (PDH ALM MON) 114 is added as shown in FIG. 7. PDH alarm monitor (PDH ALM MON) 114 monitors PDH signal input condition. When a failure is detected, the failure is reported to POH generators 102, 112 on the working and protection sides. POH generators 102, 112 fix the signal condition SC to indicate LP (low priority), and the switch condition SWC to indicate NR (no request for switchover) in the K3/K4 byte. As a result, PCA signal insertion node (for example, Node#C) continues inserting PCA signals. Types of failures detected by PDH alarm monitor (PDH ALM MON) 114 are signal break, loss of frame synchronization, alarm indication signal (AIS), line code error, etc.

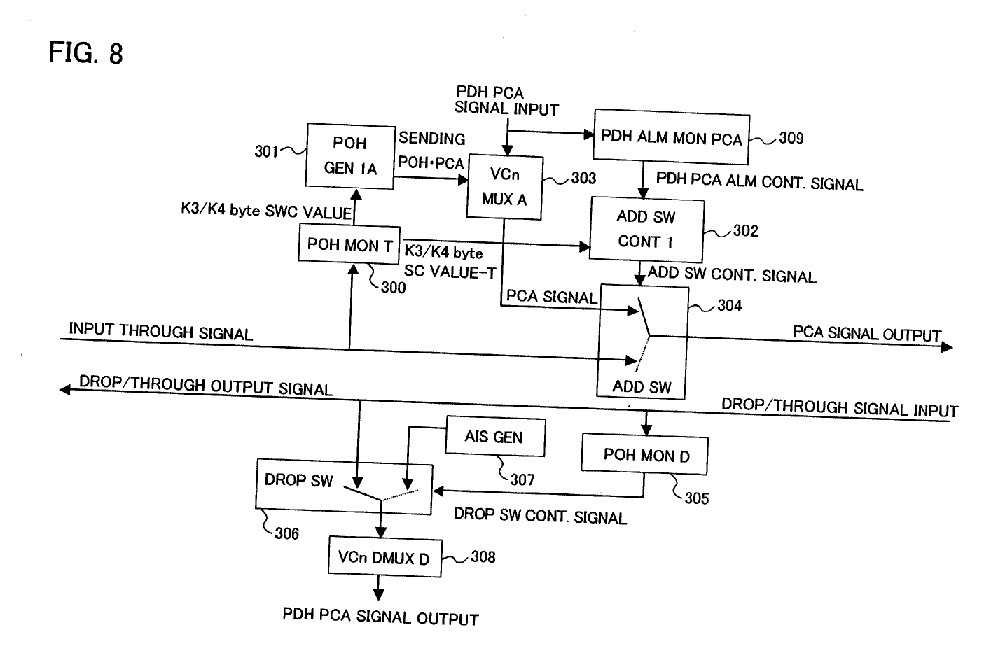

In FIG. 8, there is shown a functional block diagram of an insertion node and reception node (Node#C and Node#D in FIG. 4) corresponding to the TRP method.

In FIG. 8, a path overhead monitor (POH MON) 300 extracts a path overhead POH from a pass-through signal input, and sets the switch condition SWC value included in the K3/K4 byte into a POH generator (POH GEN) 301. Also path overhead monitor (POH MON) 300 sets the signal condition SC value in the K3/K4 byte into an insertion switch controller (ADD SW CONT) 302.

POH generator (POH GEN) 301 generates K3/K4 byte and other path overhead POH to transmit to a multiplexer (VCn MUX) 303.

Multiplexer (VCn MUX) 303 multiplexes PDH-PCA signal and transmission POH-PCA signal to generate a PCA signal.

Insertion switch controller (ADD SW CONT) 302 determines a selection condition of an insertion switch (ADD SW) 304 based on the signal condition SC value in the K3/K4 byte to control switching of insertion switch (ADD SW) 304.

A path overhead monitor (POH MONT) 305 on the drop side extracts the signal condition SC value in the K3/K4 byte from a drop/pass-through signal input to control a drop switch (DROP SW) 306. Thus, an output signal to be forwarded to a VCn demultiplexer (DMUX) 308 is selected from the inputs of either an alarm signal AIS generated by an alarm indication signal generator (AIS GEN) 307 or a drop/pass-through signal.

VCn demultiplexer (DMUX) 308 demultiplexes PDH-PCA signal from the drop/pass-through signal input.

Here, when there is a failure in PDH-PCA signal input, an ordinary UPSR (uni-directional path switch ring) configuration is to be applied without inserting PCA signal, so that VCn path switchover time can be reduced. For this purpose, a PDH-PCA alarm monitor (PDH ALM MON PCA) 309 is added, as shown in FIG. 7. PDH-PCA alarm monitor (PDH ALM MON PCA) 309 monitors a PDH-PCA signal input condition. When a failure is detected, the failure is reported to insertion switch controller (ADD SW CONT) 302.

Insertion switch controller (ADD SW CONT) 302 fixes insertion switch (ADD SW) 304 so as to select the pass-through signal as an input signal. This produces a UPSR configuration without performing the PCA function. Types of failures detected by PDH-PCA alarm monitor (PDH ALM MON PCA) 309 are signal break, loss of frame synchronization, alarm indication signal (AIS), line code error, etc.

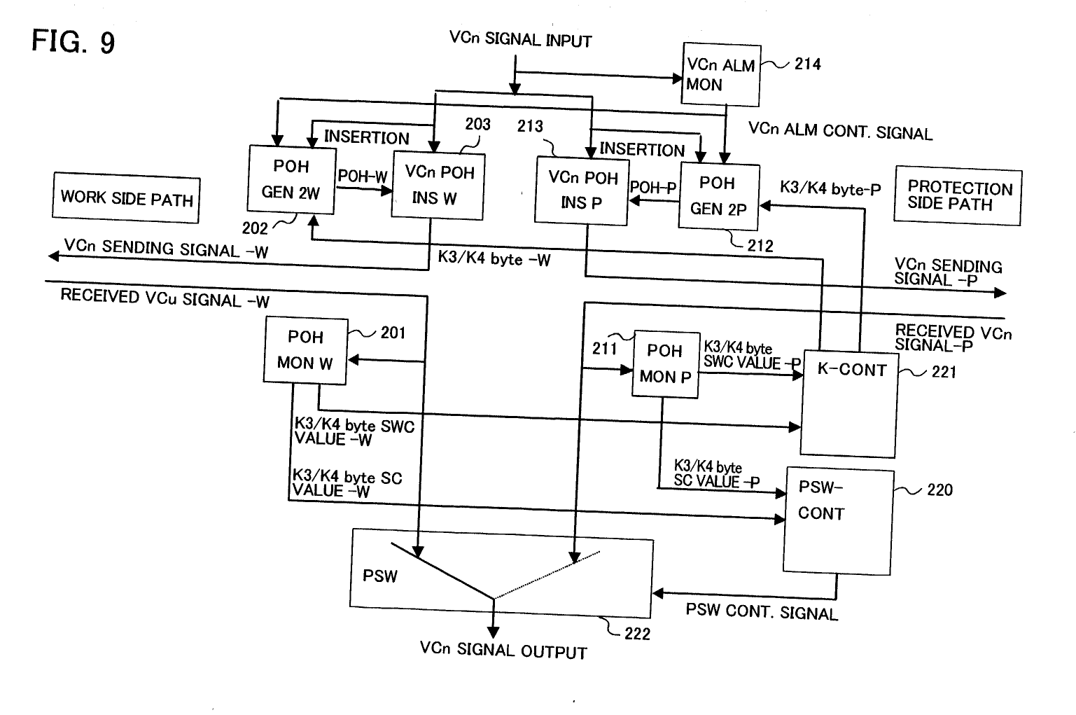

Meanwhile, in FIG. 9, there is shown a functional diagram of a PCA signal reception & transmission node (Node#A and Node#B in FIG. 4) corresponding to the SNCP method.

In FIG. 9, POH monitors 201, 211 for monitoring a path overhead POH on the working and protection sides respectively extract the path overhead POH included in the received VCn signals on the working and protection sides, to transfer the signal condition SC in the K3/K4 byte to a path switch controller (PSW-CONT) 220 and to transfer the switch condition SWC in the K3/K4 byte to a K-byte controller (K-CONT) 221.

Path switch controller (PSW-CONT) 220 determines the path selection of path switch PSW from the signal condition SC in the K3/K4 byte, to control the switchover. K-byte controller (K-CONT) 221 determines a K3/K4 byte value for setting into path overhead generators (POH GEN) 202, 212 on the working and protection sides based on the switch condition SWC value.

Path overhead generators (POH GEN) 202, 212 respectively combine the K3/K4 byte being set by K-byte controller (K-CONT) 221 with the path overhead of VCn signal input to generate a transmission path overhead on the working and protection sides.

Next, VCn/POH insertion portions (VCn POH INS) 203, 213 on the working and protection sides replaces a path overhead POH of VCn signal input with the transmission path overhead of the working and protection sides being generated in path overhead generators (POH GEN) 202, 212, to generate VCn transmission signals (P/W) of the working and protection sides.

Here, in the SNCP method, when a failure occurs in a VCn signal input, it is no use to relieve VCn signal against the failure. In such a case therefore, PCA should be continued.

For this purpose, a VCn signal input monitor (VCn ALM MON) 214 is added. VCn signal input monitor (VCn ALM MON) 214 monitors an input condition of VCn signal. When a failure is detected, VCn signal input monitor (VCn ALM MON) 214 informs path overhead generators (POH GEN) 202, 212 of the occurrence of the failure. Path overhead generators (POH GEN) 202, 212 fix the signals of the signal condition SC to indicate LP and the switch condition SWC to indicate NR in the K3/K4 byte. Thus PCA signal insertion node continues inserting PCA signals. Types of failures detected by VCn signal input monitor (VCn ALM MON) 214 are POH parity error, AIS, UNEQ, signal label mismatch, path trace mismatch, etc.

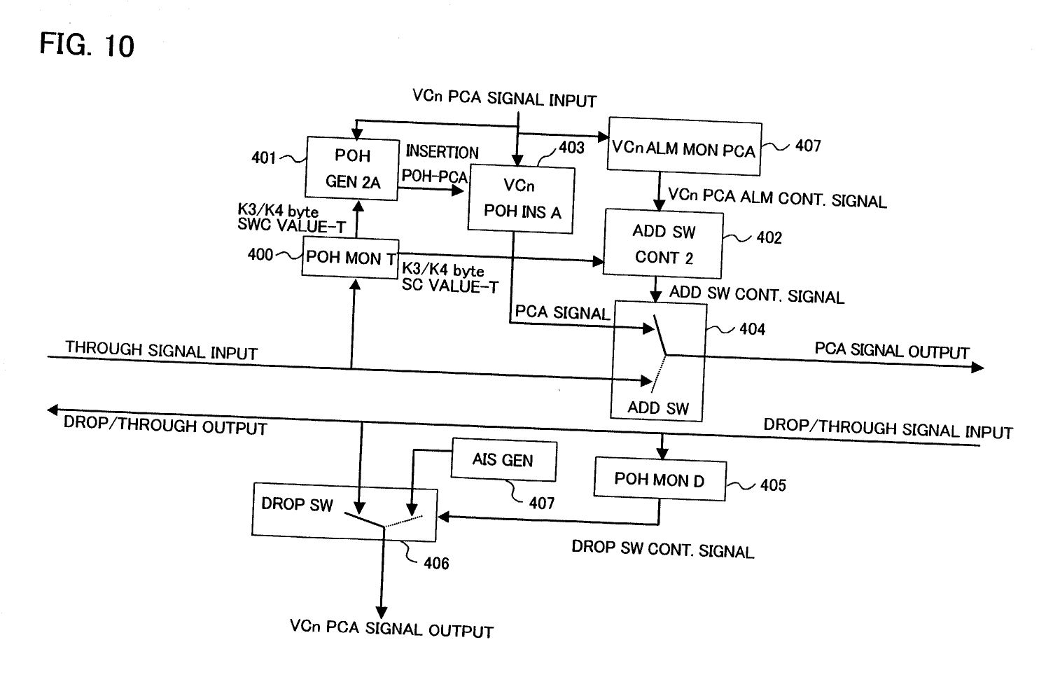

Further, in FIG. 10, there is shown a functional block diagram of in insertion node and a reception node (Node#C and Node#D in FIG. 4) corresponding to the SNCP method.

In FIG. 10, a path overhead monitor (POH MONT) 400 extracts a path overhead POH from a pass-through signal input, and sets the switch condition SWC value in the K3/K4 byte into a POH generator (POH GEN) 401. Further, path overhead monitor (POH MONT) 400 sets the signal condition SC in the K3/K4 byte into an insertion switch controller (ADD SW CONT) 402.

POH generator (POH GEN) 401 combines the path overhead POH of VCn PCA signal input with the switch condition SWC value of the K3/K4 byte being set by path overhead monitor (POH MONT) 400, to generate POH-PCA to be inserted for transmission.

A VCn POH insertion portion (VCn POH INS) 403 replaces POH of VCn PCA signal input with POH-PCA being inserted for transmission generated by POH generator (POH GEN) 401 to generate a PCA signal.

Insertion switch controller (ADD SW CONT) 402 determines the switch selection of an insertion switch (ADD SW) 404 based on the signal condition SC value in the K3/K4 byte to control insertion switch (ADD SW) 404.

A path overhead monitor (POH MONT) 405 on the drop side extracts the signal condition SC value in the K3/K4 byte from a drop/pass-through signal input to control a drop switch (DROP SW) 406. Thus, a VCn PCA signal to be output is selected from either an AIS signal generated by an alarm indication signal generator (AIS GEN) 407 or a drop signal input.

Here, when there is a failure in VCn PCA signal input, an ordinary UPSR (uni-directional path switch ring) configuration is to be applied without inserting PCA signal, so that VCn path switchover time can be reduced.

For this purpose, a VCn PCA signal input monitor (VCn ALM MON PCA) 407 is added. VCn PCA signal input monitor (VCn ALM MON PCA) 407 monitors VCn PCA signal input condition. When a failure is detected, the failure is reported to insertion switch controller (ADD SW CONT) 402. Insertion switch controller (ADD SW CONT) 402 fixes insertion switch (ADD SW) 404 so as to select a pass-through signal as an input signal. This produces a UPSR configuration without PCA function.

Types of failures detected by VCn PCA signal input monitor (VCn ALM MON PCA) 407 are POH parity error, AIS, UNEQ, signal label mismatch, path trace mismatch, etc.

Now, hereafter there are described functions of redundant path switchover and PCA signal insertion in the ring network shown in FIG. 4 being provided with PCA signal reception & transmission nodes (Node#A, Node#B) and insertion & reception nodes (Node#C, Node#D) shown in FIGS. 7 to 10.

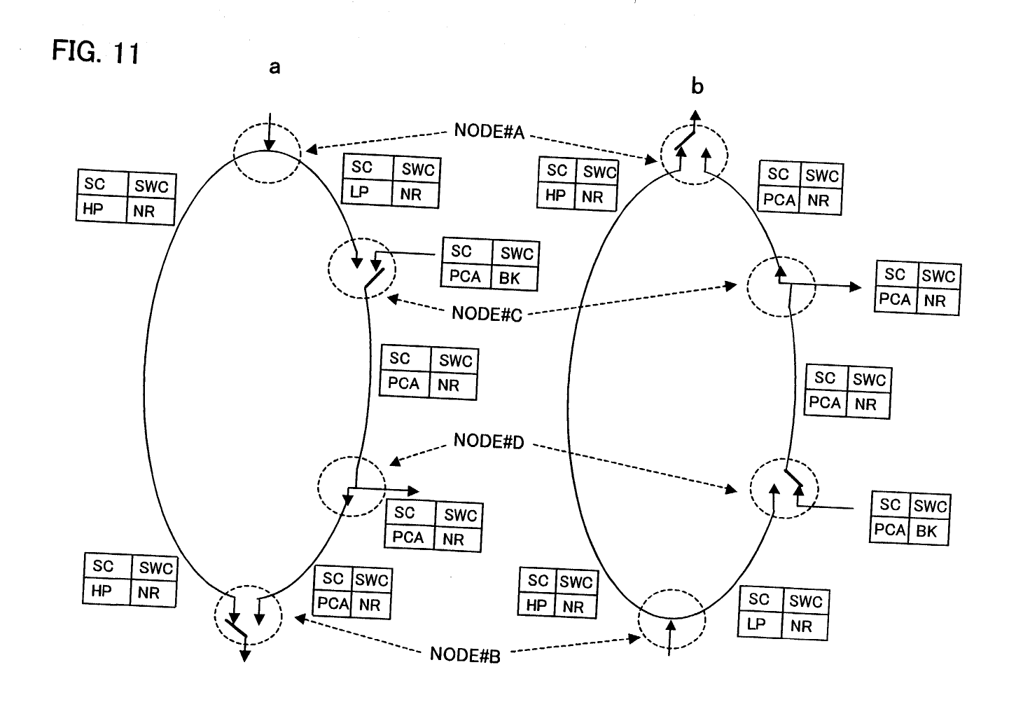

In FIG. 11, there are shown a K3/K4 byte value in an ordinary state (no failure state) and conditions of path switch (PSW), insertion switch (ADD SW) and bridge.

In this figure, for the sake of easy understanding, bi-directional signal flow between Node#A and Node#B is separately shown on the right and left side on a direction-by-direction basis. Namely, the chart ‘a’ shown on the left is a flow from Node#A to Node#B, while the chart ‘b’ shown on the right is a flow from Node#B to Node#A. This is also applied to the succeeding figures.

First, in transmission Node#A, signal transmission is performed in such a manner that, on the working path (the path on which PCA is not applied), the signal condition SC is set to HP (high priority: PCA inapplicable); and on the protection path (PCA exists in the middle of the path) the signal condition SC is set to LP (low priority: PCA applicable).

Also, when there is no failure in a reception signal in Node#A, the switch condition SWC is set to NR (no switchover request).

In PCA signal insertion Node#C, depending on the pass-through input signals in the K3/K4 byte, if the signal condition SC value is LP then PCA signal is selected and the signal condition SC is set to PCA. Also, the switch condition SWC is set to the SWC value in the K3/K4 byte of the pass-through signal to be used for transmission output.

In PCA signal dropping Node#D, when the signal condition SC value in the received K3/K4 byte is PCA, the drop signal is processed as a reception signal. When the signal condition SC value is other than PCA, an alarm indication signal (AIS) is inserted in the drop signal.

Further, in reception Node#B, each signal condition SC in the K3/K4 byte in both directions is monitored. Based on the monitored result, the path in which the signal condition SC is HP (PCA inapplicable) is selected. When both working path and protection path have the value HP (PCA inapplicable), then the working path is selected.

The above description is also applied to the flow in the direction from Node#B to Node#A shown in the figure ‘b’ on the right hand. Namely, the above description is applicable when substituting each other between Node#A and Node#B, and between Node#C and Node#D, while K3/K4 byte value and conditions of path switch (PSW), insertion switch (ADD SW) and bridge are remained as they are.

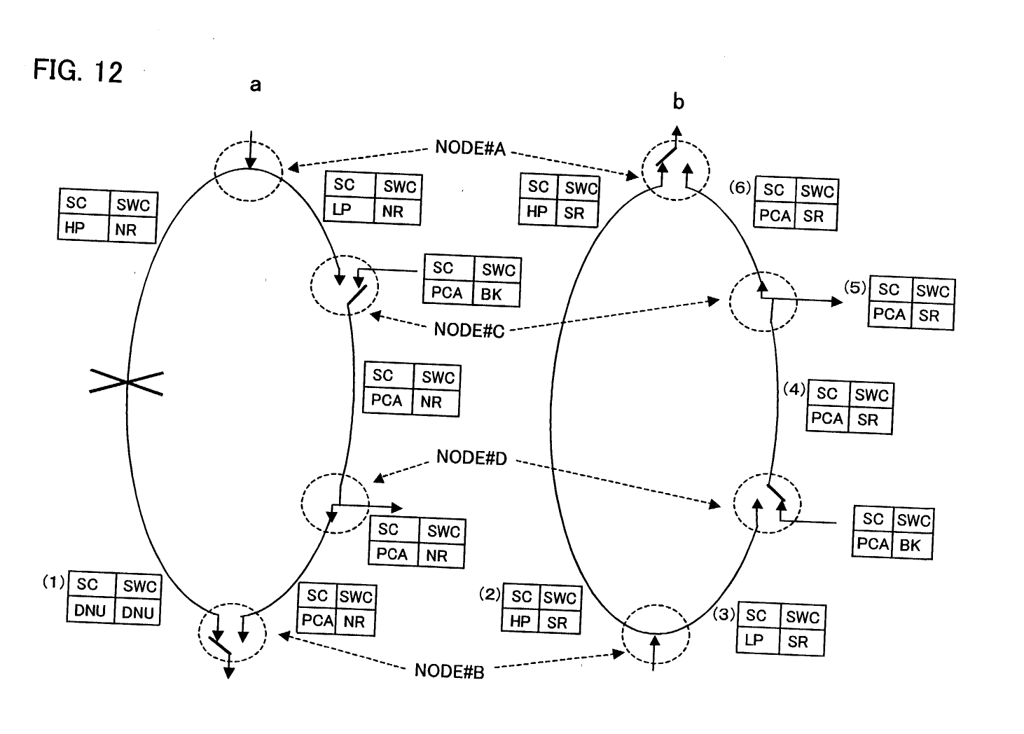

Next, referring to FIGS. 12 to 15, an operation in case of failure is explained hereafter. In these figures, each number in the parentheses, (n), corresponds to the following explanation of each step having the identical number, also indicating a sequence of transitions or operations in order.

In FIGS. 11 and 12, an example of a failure occurring on the working side from Node#A to Node#B is shown. The cause of the failure is a break of the transmission line fiber or the like, whereby the entire signals on the path become ‘1’ in Node#B in FIG. 12. Node#B receives in the K3/K4 byte the signal condition SC=DNU (use forbidden) and the switch condition SWC=DNU (use forbidden) (step (1)).

Node#B then sets the switch condition SWC=SR (request for switchover) in the K3/K4 byte in both directions from Node#B to Node#A to transmit (steps (2), (3)).

In Node#D, the switch condition SWC=SR which is the pass-through input value is set into K3/K4 byte to output (step (4)).

As a result, the switch condition SWC=SR of the K3/K4 byte is input to both the working path and the protection path of Node#A (step (2) and step (6)).

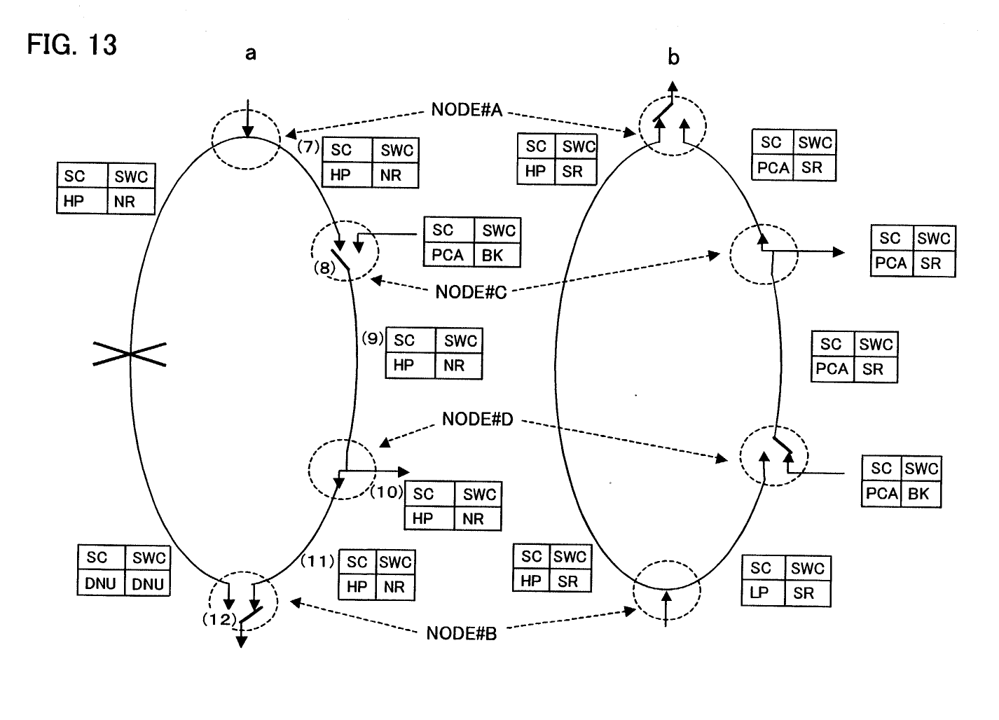

Continuing to FIG. 13, when Node#A receives the switch condition SWC=SR in the K3/K4 byte, Node#A sets the signal condition SC=HP (PCA inapplicable) in the K3/K4 byte on the protection path to transmit (step (7)).

When Node#C receives the signal condition SC=HP in the K3/K4 byte of the pass-through input, Node#C sets selection switch SW to the pass-through input side (step (8)). Thus the pass-through input signal is output (step (9)).

In Node#D, on receiving the signal condition SC=HP in the K3/K4 byte of the input signal, Node#D inserts an alarm signal AIS into the drop signal (step (10)), and thus the PCA line directed from Node#C to Node#D is disconnected.

In Node#B, on receiving the signal condition SC=HP in the K3/K4 byte on the protection path (step (11)) Node#B determines the protection path is available, and accordingly switches the path switch to the protection path side (step (12)).

Through the aforementioned procedure, a switchover in the direction from Node#A to Node#B is completed.

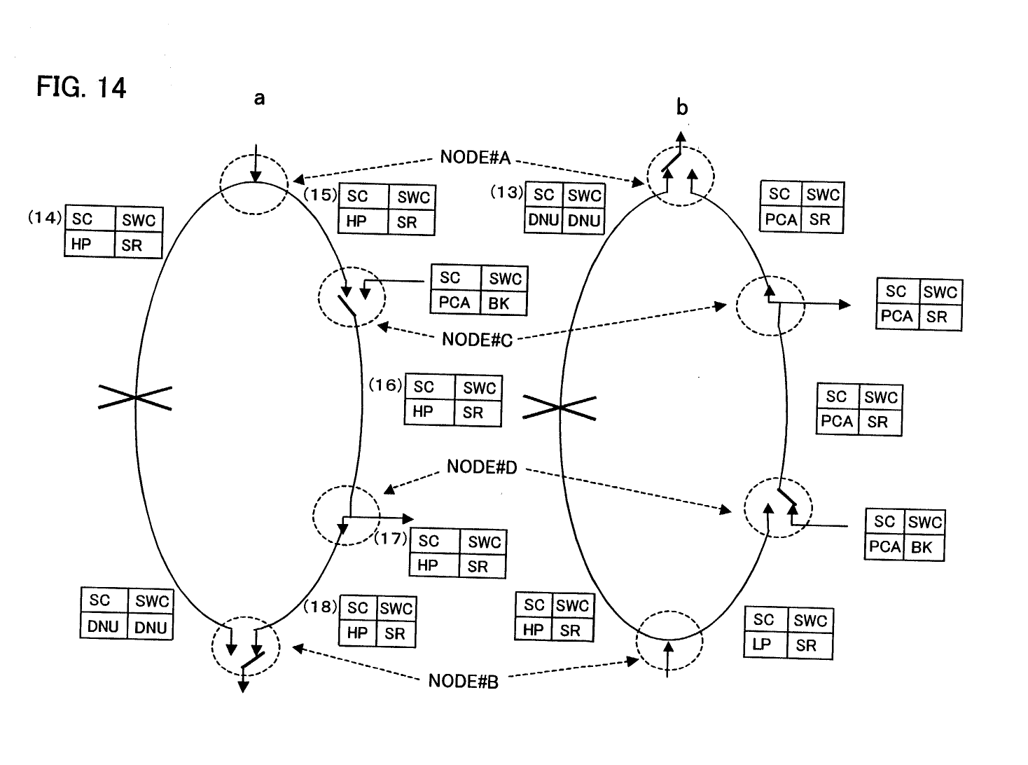

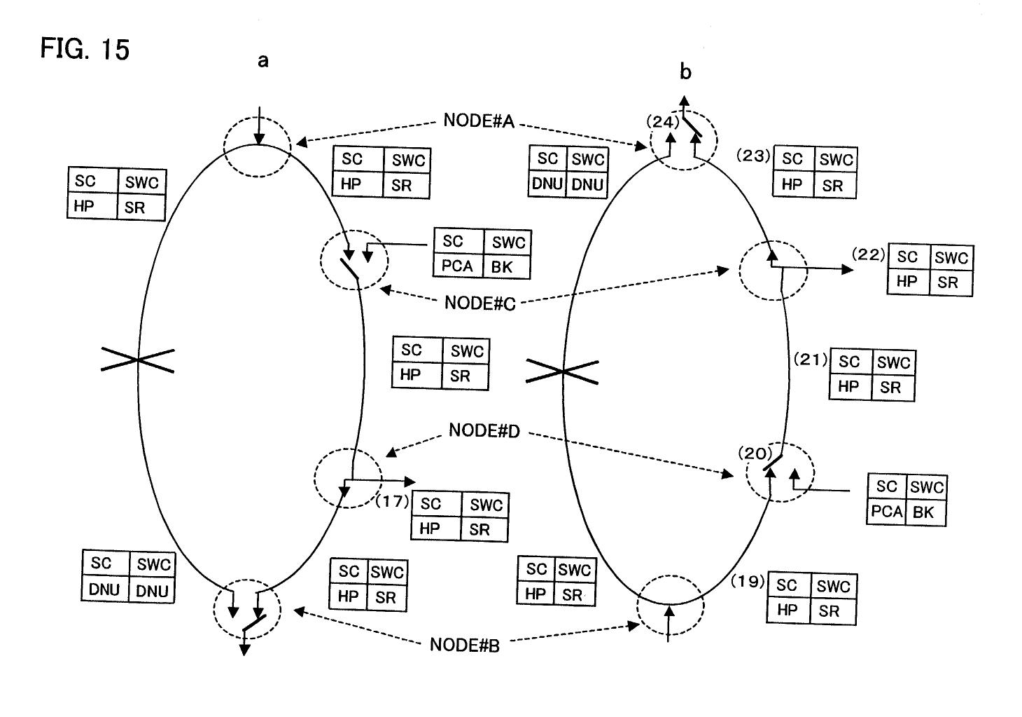

Next, in the following description, there is considered a case that another failure occurs on the working path directed from Node#B to Node#A in addition to the aforementioned failure on the working path from Node#A to Node#B. This case is explained referring to FIGS. 14 and 15.

In FIG. 14, Node#A receives the signal condition SC=DNU (use forbidden) and also the switch condition SWC=DNU (use forbidden) in the K3/K4 byte on the working path (step (13)).

Node#A then sets the switch condition SWC=SR (request for switchover) into K3/K4 byte to transmit in the direction from Node#A to Node#B (steps (14), (15)).

In Node#C, the switch condition SWC=SR in the pass-through input is set into K3/K4 byte to output without modification (step (16)). As a result, the switch condition SWC=SR in the K3/K4 byte is input to the protection path side of Node#A (step (18)).

Continuing to FIG. 15, Node#B, on receipt of Switch condition SWC=SR in the K3/K4 byte, sets the signal condition SC=HP (PCA applicable) in the K3/K4 byte of the protection path side to transmit (step (19)).

In Node#D, when receiving the signal condition SC=HP in the K3/K4 byte of the pass-through input, Node#D switches the selection switch SW to pass through the input (step (20)). Thus the pass-through input is output (step (21)).

In Node#C, when receiving the signal condition SC=HP in the K3/K4 byte of the input signal, Node#C inserts an alarm signal AIS into a drop signal (step (22)). Thus the PCA line directed from Node#D to Node#C is disconnected.

In Node#A, when receiving the signal condition SC=HP in the K3/K4 byte of the protection path, Node#A determines the protection path is available (step (23)), and switches the path switch to the protection path side (step (24)).

In the above-mentioned manner, a failure switchover in the direction from Node#B to Node#A is completed.

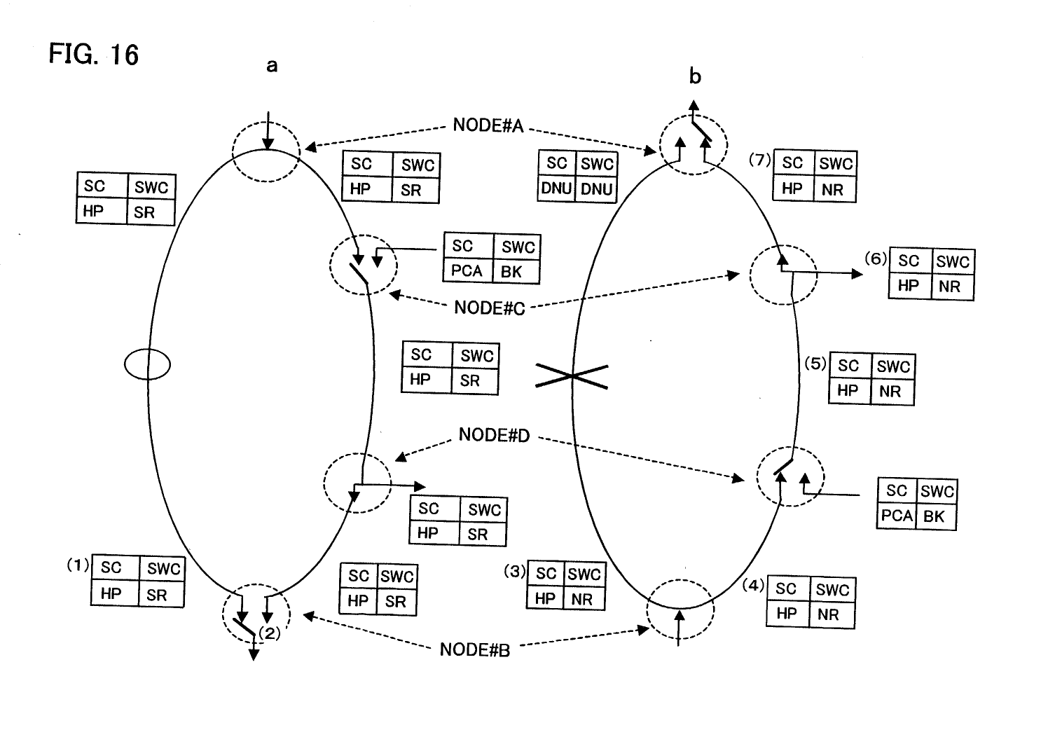

Next, referring to FIGS. 16 to 19, the restoration operation procedure in accordance with the present invention is explained hereafter.

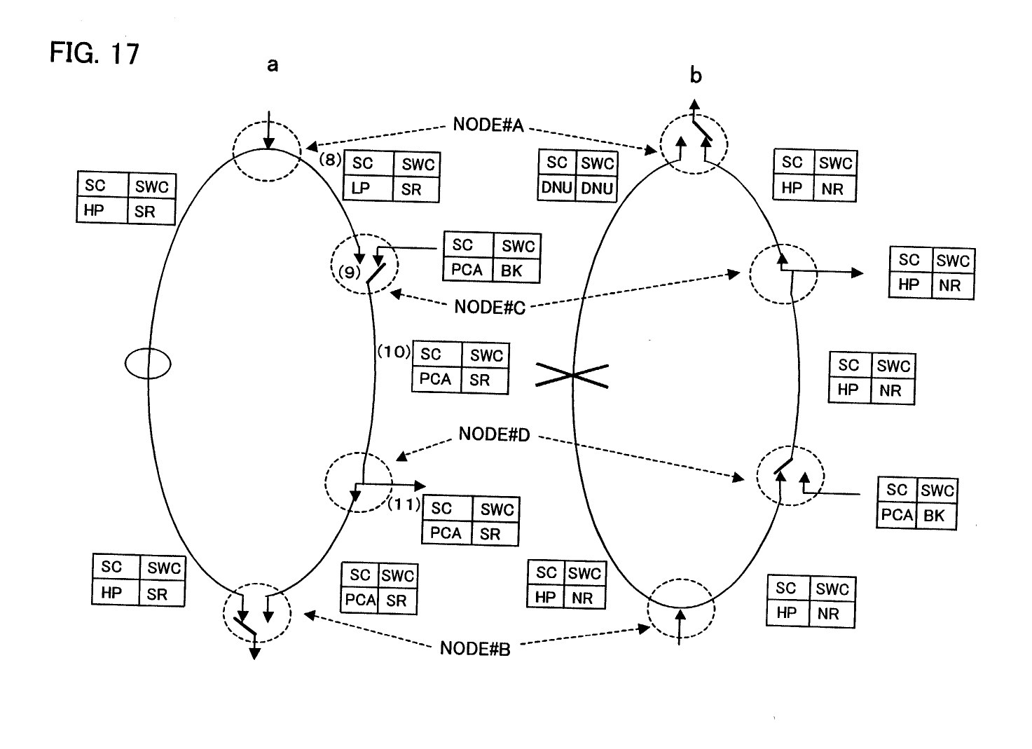

In FIGS. 16 and 17, there is illustrated an operation when a fault on the path from Node#A to Node#B is restored.

In FIG. 16, when Node#B receives the signal condition SC=HP in the K3/K4 byte on the working path (step (1)), Node#B determines the working path is available and switches the path switch onto the working path side (step (2)).

Because the path switch is restored, Node#B transmits the switch condition SWC=NR (no request for switchover) in the K3/K4 byte onto both working path and protection path (steps (3), (4)).

Node#D then transfers Switch condition SWC=NR in the K3/K4 byte (step (5)). In Node#C, this signal is included in the drop signal and also transferred to the succeeding node (step (7)). Thus Node#A receives the switch condition SWC=NR in the K3/K4 byte on the protection path.

Continuing to FIG. 17, when Node#A receives the switch condition SWC=NR in the K3/K4 byte, Node#A sets the signal condition SC=LP (PCA applicable) in the K3/K4 byte on the protection path, to transmit (step (8)).

When Node#C receives the signal condition SC=LP in the K3/K4 byte of the pass-through input, Node#C switches over selection switch SW to PCA signal side (step (9)), and sets the signal condition SC=PCA into K3/K4 byte to output (step (10)).

In Node#D, determining from the signal condition SC=PCA in the K3/K4 byte of the input signal, Node#D removes the insertion of alarm indication signal (AIS) in the drop signal (step (11)). Thus the PCA line from Node#C directed to Node#D is restored.

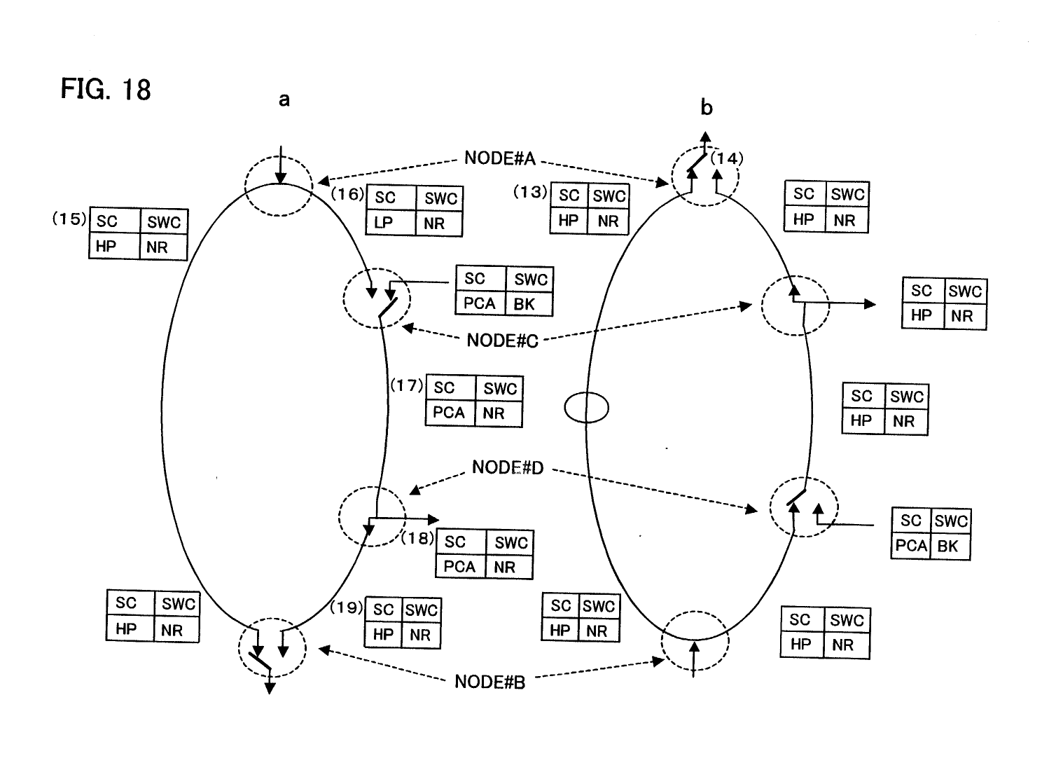

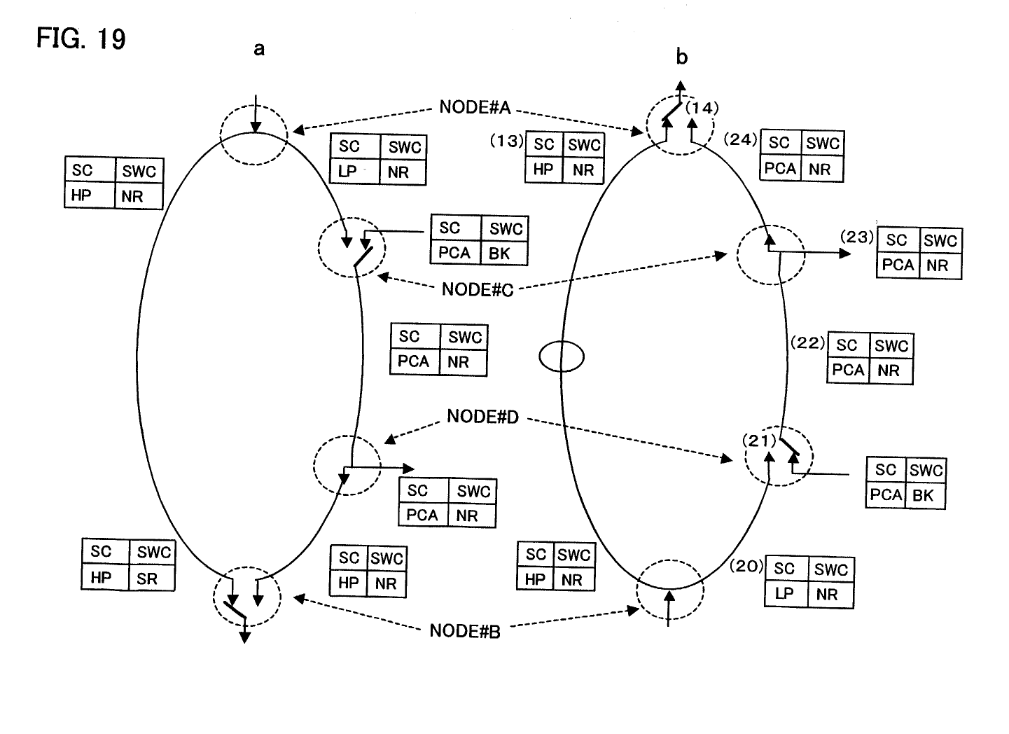

Further, in this state, an operation when the failure is restored on the working path from Node#B to Node#A is illustrated in FIGS. 18 and 19. In FIG. 18, when Node#A receives the signal condition SC=HP in the K3/K4 byte on the working path (step (13)), Node#A determines the working path is now available and accordingly switches the path switch onto the working path side (step (14)).

Because the path switch is restored, Node#A transmits the switch condition SWC=NR (no request for switchover) in the K3/K4 byte onto both working path and protection path (steps (15), (16)). Node#C and Node#D then transfers the switch condition SWC=NR in the K3/K4 byte (step (17)). Further in Node#D, this switch condition SWC=NR is dropped (step (18)). Thus Node#B receives the switch condition SWC=NR in the K3/K4 byte on both working path and protection path (step (19)).

Continuing to FIG. 19, when Node#B receives the switch condition SWC=NR in the K3/K4 byte, Node#B sets the signal condition SC=LP in the K3/K4 byte onto the protection path, to transmit (step (20)).

When Node#D receives the signal condition SC=LP in the K3/K4 byte of the pass-through input, Node#D switches over selection switch SW to PCA signal side (step (21)), and sets the signal condition SC=PCA into K3/K4 byte to output (step (22)).

In Node#C, determining from the signal condition SC=PCA in the K3/K4 byte of the input signal, Node#C removes the insertion of alarm indication signal (AIS) in the drop signal (step (23)). At the same time, Node#C passes through the signal condition SC=PCA in the K3/K4 byte to direct to Node#A (step (24)).

Thus the PCA line from Node#D directed to Node#C is restored.

As can be understood from the embodiment having been illustrated, the present invention enables to provide an improved UPSR method having Protection Channel Access (PCA) method to achieve increased network capacity, while maintaining simplicity of circuit configuration and switchover control.

It is to be noted that the foregoing description of the embodiments is not intended to limit the invention to the particular details of the examples illustrated. Any suitable modification and equivalents may be resorted to the scope of the invention. All features and advantages of the invention which fall within the scope of the invention are covered by the appended claims.

What is claimed is:

1. An SDH ring network comprising:
a transmission & reception node; and
a PCA insertion & reception node, which are interconnected in a ring form,
the transmission & reception node including,
a first function portion for setting a working path and a protection path in advance,
a second function portion for setting a transmission value into the K3 or K4 byte in the overhead part of an SDH signal independently on the working path and the protection path, and
a path switch for selecting either the working path or the protection path depending on the state of the received K3 or K4 byte, and
the PCA insertion & reception node including,
an insertion switch for selecting either a received signal is to be passed through or a PCA (Protection Channel Access) signal is to be inserted thereto, and
a bridge for dropping a received signal and at the same time passing through the received signal.

2. The SDH ring network according to claim 1, wherein, in regard to transmission values in the K3 or K4 byte to be set by the transmission & reception node, when the network is maintained in an ordinary state having no failure, a signal condition SC indicating ‘PCA inapplicable’ is set for the working path, while a signal condition SC indicating ‘PCA applicable’ and a switch condition SWC indicating ‘switchover not requested’ are set for the protection path, and
when a failure is detected on the working path, a switch condition SWC indicating ‘request for switchover’ is set to transmit, and on receipt of the switch condition SWC indicating ‘request for switchover’, a signal condition SC indicating ‘PCA inapplicable’ is set for the protection path.

3. The SDH ring network according to claim 1,
wherein, when receiving a pass-through signal having the signal condition SC of ‘PCA applicable’ in the K3 or K4 byte, the PCA insertion & reception node selects PCA signal to transmit a PCA output signal, in which a switch condition SWC is replaced with the switch condition SWC received in the K3 or K4 byte of a pass-through signal input, and a signal condition SC indicating ‘PCA’ is set into the K3 or K4 byte, and
when receiving a pass-through signal having the signal condition SC of ‘PCA inapplicable’ in the K3 or K4 byte, the PCA insertion & reception node selects the pass-through signal input and outputs the pass-through signal input to the PCA output signal.

4. The SDH ring network according to claim 1,
wherein, when receiving a drop or pass-through signal having a signal condition SC of ‘PCA’ in the K3 or K4 byte, the PCA insertion & reception node selects a PCA signal in the pass-through signal input and outputs the PCA signal, and
when receiving a drop or pass-through signal having a signal condition SC of other than ‘PCA’ in the K3 or K4 byte, the PCA insertion & reception node outputs an alarm indication signal (AIS) in the PCA output signal.

5. The SDH ring network according to claim 2,
wherein the transmission & reception node monitors a PDH input signal and, on detection of a failure in the PDH input signal, the transmission & reception node fixes a signal condition SC indicating ‘PCA applicable’ and a switch condition SWC indicating ‘no request for switchover’ in the K3 or K4 byte for the protection path, and the PCA insertion node continues inserting a PCA signal.

6. The SDH ring network according to claim 2,
wherein the transmission & reception node monitors a VCn input signal, and on detection of a failure in the VCn input signal, the transmission & reception node fixes a signal condition SC indicating ‘PCA applicable’ and a switch condition SWC indicating ‘no request for switchover’ in the K3 or K4 byte for the protection path, and the PCA insertion node continues inserting a PCA signal.

7. The SDH ring network according to claim 2,
wherein the PCA insertion & reception node monitors a PDH PCA signal input, and on detection of a failure in the PDH PCA signal input, the PCA insertion & reception node fixes a selection condition so as to select a pass-through signal input, to obtain the UPSR configuration without applying PCA so as to shorten a failure relief time.

8. The SDH ring network according to claim 2,
wherein the PCA insertion & reception node monitors a VCn PCA signal input, and on detection of a failure in the VCn PCA signal input, the PCA insertion & reception node fixes a selection condition so as to select a pass-through signal input, to obtain the UPSR configuration without applying PCA.

9. The SDH ring network according to claim 3,
wherein the transmission & reception node monitors a PDH input signal and, on detection of a failure in the PDH input signal, the transmission & reception node fixes a signal condition SC indicating ‘PCA applicable’ and a switch condition SWC indicating ‘no request for switchover’ in the K3 or K4 byte for the protection path, and the PCA insertion node continues inserting a PCA signal.

10. The SDH ring network according to claim 3,
wherein the transmission & reception node monitors a VCn input signal, and on detection of a failure in the VCn input signal, the transmission & reception node fixes a signal condition SC indicating ‘PCA applicable’ and a switch condition SWC indicating ‘no request for switchover’ in the K3 or K4 byte for the protection path, and the PCA insertion node continues inserting a PCA signal.

11. The SDH ring network according to claim 3,
wherein the PCA insertion & reception node monitors a PDH PCA signal input, and on detection of a failure in the PDH PCA signal input, the PCA insertion & reception node fixes a selection condition so as to select a pass-through signal input, to obtain the UPSR configuration without applying PCA so as to shorten a failure relief time.

12. The SDH ring network according to claim 3, wherein the PCA insertion & reception node monitors a VCn PCA signal input, and on detection of a failure in the VCn PCA signal input, the PCA insertion & reception node fixes a selection condition so as to select a pass-through signal input, to obtain the UPSR configuration without applying PCA.

13. The SDH ring network according to claim 4,
wherein the transmission & reception node monitors a PDH input signal and, on detection of a failure in the PDH input signal, the transmission & reception node fixes a signal condition SC indicating ‘PCA applicable’ and a switch condition SWC indicating ‘no request for switchover’ in the K3 or K4 byte for the protection path, and the PCA insertion node continues inserting a PCA signal.

14. The SDH ring network according to claim 4,
wherein the transmission & reception node monitors a VCn input signal, and on detection of a failure in the VCn input signal, the transmission & reception node fixes a signal condition SC indicating ‘PCA applicable’ and a switch condition SWC indicating ‘no request for switchover’ in the K3 or K4 byte for the protection path, and the PCA insertion node continues inserting a PCA signal.

15. The SDH ring network according to claim 4,
wherein the PCA insertion & reception node monitors a PDH PCA signal input, and on detection of a failure in the PDH PCA signal input, the PCA insertion & reception node fixes a selection condition so as to select a pass-through signal input, to obtain the UPSR configuration without applying PCA so as to shorten a failure relief time.

16. The SDH ring network according to claim 4, wherein the PCA insertion & reception node monitors a VCn PCA signal input, and on detection of a failure in the VCn PCA signal input, the PCA insertion & reception node fixes a selection condition so as to select a pass-through signal input, to obtain the UPSR configuration without applying PCA.
